(19) United States
(12) Patent Application Publication
(10) Pub. No.: US 2012/0181890 A1
(43) Pub. Date: Jul. 19, 2012

(54) METHOD AND SYSTEM FOR JOINING STATOR WIRES

(75) Inventors: Richard M. Kleber, Clarkston, MI (US); David R. Sigler, Shelby Township, MI (US)

(73) Assignee: GM GLOBAL TECHNOLOGY OPERATIONS LLC, Detroit, MI (US)

(21) Appl. No.: 13/009,138

(22) Filed: Jan. 19, 2011

(51) Int. Cl. H02K 3/28; H02K 15/00; H02K 15/02

(52) U.S. Cl. 310/201; 29/596; 29/732

(57) ABSTRACT

A method and system is provided to join the wire ends of a stator by immersing a wire end portion of the stator in a molten solder bath to form a solder joint in each of a plurality of wire end pairs to provide an electrical connection between the respective wire ends of each wire end pair. The stator may be configured as a bar pin stator including a plurality of bar pins defining the wire ends. The solder joint may be defined by a portion of solder between the proximate surfaces of the wire ends of each wire end pair, and may be defined by a coating of solder in proximate contact with the perimeter surface of each respective wire end pair, wherein the portion of solder and the coating of solder each may provide an electrical connection between the respective wire ends.

### TECHNICAL FIELD

The present invention relates to a method and system for joining the stator wires of electric devices.

### BACKGROUND

Electric devices such as motors and generators having a stator secured within a housing of the motor/generator are well known. A rotor mounted on a shaft is coaxially positioned within the stator and is rotatable relative to the stator about the longitudinal axis of the shaft to transmit the force capacity of the motor. The passage of current through the stator creates a magnetic field tending to rotate the rotor and shaft.

Some stators are generally configured as an annular ring and are formed by stacking thin plates, or laminations, of highly magnetic steel. A copper winding of a specific pattern is configured, typically in slots of the lamination stack, through which current is flowed to magnetize sections of the stator assembly and to create a force reaction that causes the rotation of the rotor.

Bar pin stators are a particular type of stator that include a winding formed from a plurality of bar pins, or bar pin wires. The bar pin wires are formed from a heavy gauge copper wire with a rectangular cross section and generally configured in a hairpin shape having a curved section and typically terminating in two wire ends. The bar pins are accurately formed into a predetermined shape for insertion into specific rectangular slots in the stator, and are typically coated with an insulating material prior to insertion, such that the adjacent surfaces of the pins within the slots are electrically insulated from each other.

Typically, the curved ends of the bar pins protrude from one end of the lamination stack and the wire ends of the bar pins protrude from the opposite end of the lamination stack. After insertion, the portions of the wire protruding from the lamination stack are bent to form a complex weave from wire to wire, creating a plurality of wire end pairs. Adjacent paired wire ends are typically joined to form an electrical connection by welding one wire end to its adjacent or paired wire end to form a welded joint, where each pair of wires is individually welded, for example, by arc welding. The resultant weave pattern and plurality of welded joints determines the flow of current through the motor. To facilitate welding of the wire ends, the wire ends of the bar pins are typically stripped of insulation prior to insertion into the lamination stack and bending into the weave pattern. Electrical conductivity and structural integrity of the welded joint between each of the paired wire ends is a key determiner of motor quality and performance. Joint quality can be affected by the geometry of the wire ends, cleanliness of the wire surfaces prior to welding, defects such as porosity and microcracks introduced into the weld, spatter produced in the arc welding process, the cross-sectional or surface area of the weld and other factors. The process of arc welding each wire pair joint individually is time consuming, inconsistent, and not robust. Variability in the process and configuration of each wire end pair results in variability in the electrical connection of each wire end pair. This may result in thermal variation in the operation of the motor, localized overloading of the welded joint causing an electrical discontinuity in the winding due to, for example, welds of minimal surface or cross-sectional area or with a small heat-affected zone, or due to weld splatter between wire end pairs.

### SUMMARY

A method and system of joining the wire ends of a stator assembly by immersing a wire end portion of the stator assembly in a molten solder bath is provided. The wire end portion includes a plurality of wire ends configured as a plurality of wire end pairs. Each of the plurality of wire ends is wetted by molten solder during immersion in the molten solder bath, and the molten solder is solidified to form a plurality of solder joints. Each solder joint is configured to join the wire ends of a respective wire end pair, to provide an electrical connection between the wire ends of the respective wire end pair.

The method may further include ultrasonically activating the solder bath such that each of the plurality of wire ends becomes wetted by the molten solder. The method may include controlling the process of immersing the wire end portion into the molten solder bath by one or more of controlling the duration of immersion of the wire end portion in the molten solder bath to a predetermined time, controlling the temperature of the molten solder bath to a predetermined temperature, controlling the viscosity of the molten solder bath to a predetermined viscosity, and controlling the depth of immersion of the wire end portion in the molten solder bath, to ensure that each of the plurality of wire ends is wetted by molten solder sufficiently to form a solder joint with the wire ends of each respective pair of wire ends, the solder joint having structural integrity and configured to provide an electrical connection between the wire ends in the respective wire end pair.

The stator assembly may be configured as a bar pin stator including a plurality of bar pins, each bar pin including one or more wire ends. The plurality of wire ends may be configured in a weave pattern defining a plurality of wire end pairs, and may further be configured in one or more winding sets. The solder joint of each of the wire end pairs forms an electrical connection such that an electrical current is conductible through the weave pattern and/or each winding set.

The plurality of wire end pairs may be configured to separate each wire end pair from an adjacent wire end pair, to prevent wicking of the molten solder therebetween during immersion in the molten solder bath. The winding sets, and/or adjacent wire end pairs may be separated from each other by a separator during immersion of the wire end portion in the molten solder bath, to prevent formation of a solder joint providing an electrical connection between the winding sets and/or between adjacent pairs of wire ends.

The method and system may further include immersing the wire end portion in a preconditioning bath, or by applying a flux to the wire ends prior to immersing the wire end portion in the molten solder bath, to prepare the wire ends for soldering by cleaning and/or removing oxidation from the wire ends to facilitate wetting of the wire ends by the molten solder. The method or system may include pre-applying solder to the wire ends of the bar pins, which may occur after stripping the wire ends and prior to bending the wire to form the bar pin, to facilitate wetting of the wire ends by the molten solder during immersion in the solder bath. The method and system may also include presenting the stator assembly for immersion in the molten solder bath using one of a conveyor, a robot or other mechanized system.

The solder joint may be defined by a portion of solder between the proximate surfaces of the wire ends of each wire end pair, and may be further defined by a coating of solder in contact with the perimeter surfaces of each respective wire end pair, wherein the portion of solder and the coating of solder may each provide an electrical connection between the respective wire ends. The solder joint, including the portion of solder between the proximate surfaces of the wire end pair and the coating of solder, provides an increased surface area to carry current as compared with an arc welded joint, therefore improving the electrical performance and decreasing the susceptibility of the rotor to overloading and electrical shorts. Further, the soldering operation to join one wire end to another is less sensitive to fit variation between the proximate surfaces of the wire ends being joined, in comparison with a welding process, due to the capability to wick filler solder into the space between the proximate surfaces of the paired wire ends, thereby decreasing the influence of weave pattern accuracy and wire to wire fit on electrical connection quality of the joint.

Additional advantages include lower manufacturing cost by reducing processing costs and throughput time for the joining of the stator wires. The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a stator assembly prior to joining the wire ends of the stator winding;

FIG. 2 is a partial schematic perspective view of the wire end portion of the stator assembly of FIG. 1;

FIG. 3A is a partial cross-sectional schematic illustration of the wire end portion of the stator of FIG. 2;

FIG. 3B is a partial cross-sectional schematic illustration of the wire end portion of FIG. 3A;

FIG. 4 is a partial schematic illustration of the wire end portion of the stator in a solder bath;

FIG. 5 is a partial schematic illustration of the wire end portion of the stator after soldering; and

FIG. 6A is a partial cross-sectional schematic illustration of the wire end portion of FIG. 5; and

FIG. 6B is a partial cross-section schematic illustration of the wire end portion of FIG. 5 including a separator.

### DETAILED DESCRIPTION

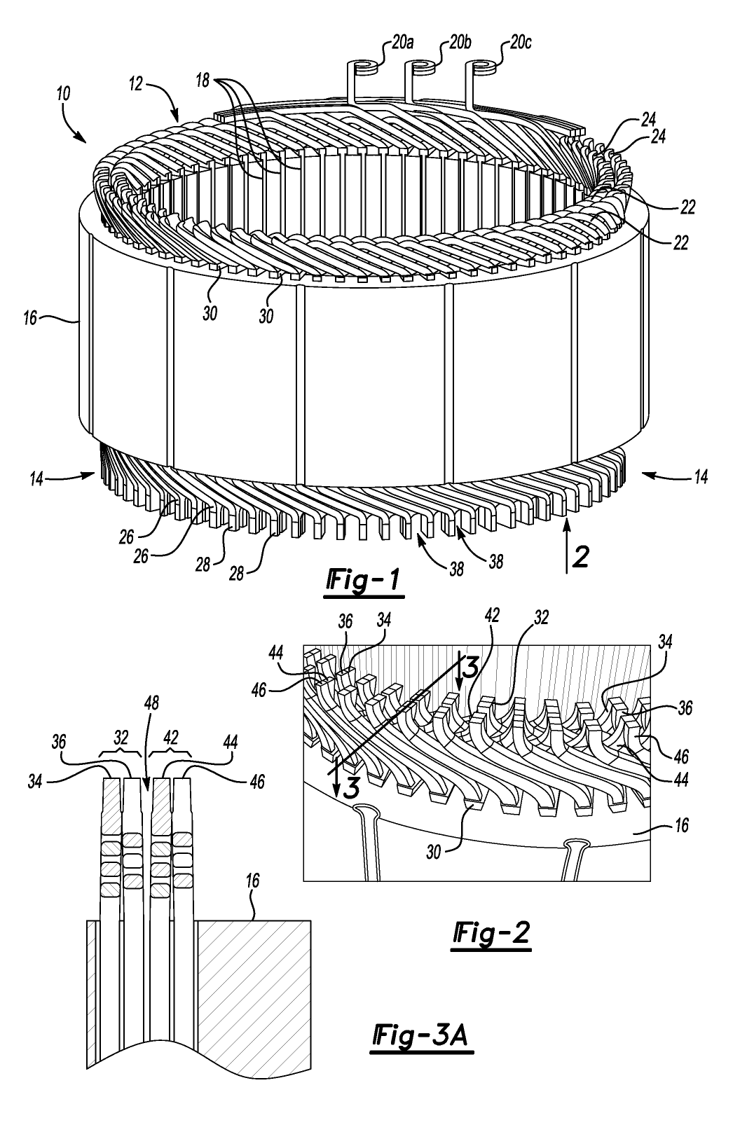

Referring to the drawings wherein like reference numbers represent like components throughout the several figures, the elements shown in FIGS. 1-6B are not to scale or proportion. Accordingly, the particular dimensions and applications provided in the drawings presented herein are not to be considered limiting. A method and system of joining the wire ends of a stator assembly by immersing a wire end portion of a stator assembly in a molten solder bath is provided. FIG. 1 shows a stator assembly 10, also referred to as a stator, prior to joining of wire ends 28 by soldering. The stator 10 is generally configured as an annular ring and includes a lamination stack 16, which is formed by stacking laminations in a specific pattern. Each lamination includes a plurality of radially distributed slots which are oriented during assembly of the lamination stack 16 to define a plurality of generally rectangular slots 18 which are distributed radially and extend from end to end of the stack 16.

The stator 10 is shown in FIG. 1 configured as a bar pin stator, wherein a winding 12 is formed from a plurality of bar pins 24, also referred to as bar pin wires. Winding 12 may also include terminals or connections 20a, 20b and 20c, for connecting the various phases of the winding 12. The bar pin wires 24 are typically formed from a heavy gauge, high conductivity copper wire with a rectangular cross section and each bar pin wire 24 is generally configured in a hairpin shape having a curved section 22 and typically terminating in two wire ends 28. The bar pins 24 are accurately formed into a predetermined shape for insertion into the slots 18 in a predetermined weave pattern. The bar pins 24 are typically coated with an insulating material 26 prior to insertion, such that the adjacent surfaces of the bar pins 24 within the slots 18 are electrically insulated from each other. To facilitate joining of the wire ends 28 to form an electrical connection, the wire ends 28 of the bar pins 24 are typically stripped of the insulating layer 26 prior to insertion into the slots 18 of the lamination stack 16 and prior to bending to form a weave pattern such as the weave pattern shown in FIG. 1 and in additional detail in FIG. 2. Each slot 18 may be lined with a slot liner 30, to insulate the bar pins 24 from the lamination stack 16, and to prevent damage to the insulating layer 26 during insertion of the bar pins 24 in the slots 18.

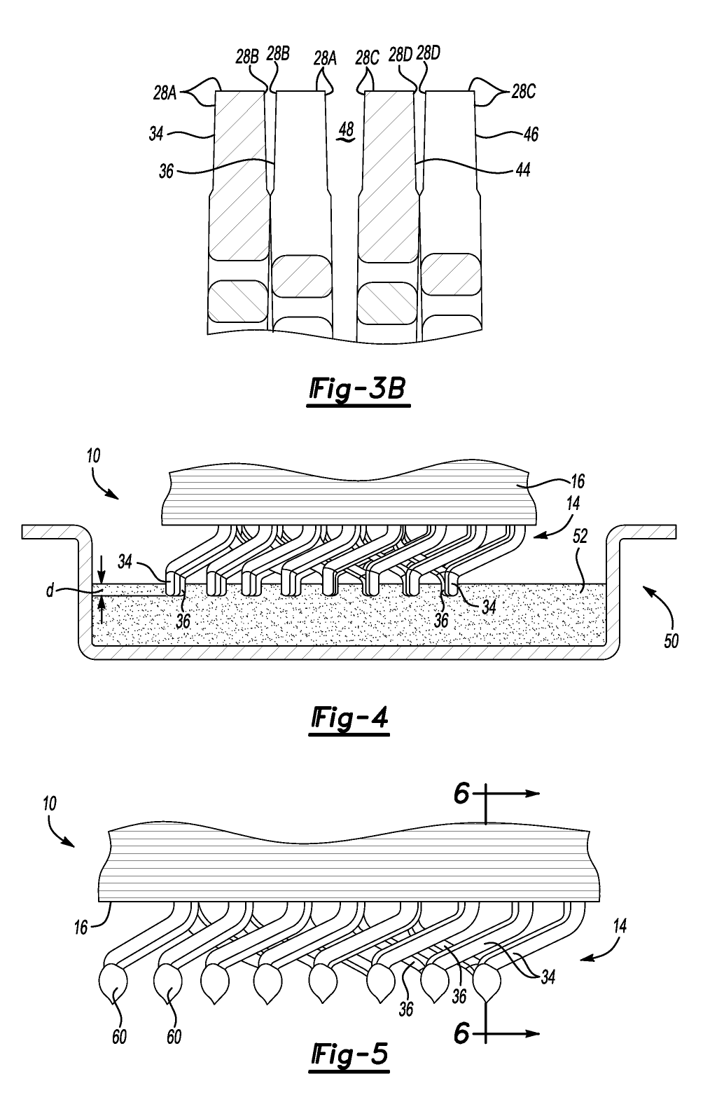

FIG. 1 shows the curved ends 22 of the bar pins 24 protruding from one end of the lamination stack 16 and the wire ends 28 of the bar pins 24 protruding from the opposite end of the lamination stack 16. After insertion, the wire ends 28 protruding from the lamination stack 16 are bent to form a complex weave from wire to wire, wherein the plurality of bent wire ends 28 is generally referred to as the wire end portion 14 of the stator 10. The wire ends 28 of the bar pins 24 extending through the slots 18 are bent to a desired configuration, as shown in FIG. 1 and in additional detail in FIG. 2, so each respective wire end 28 may be paired with and joined to a different wire end 28 according to the connection requirements of the winding 12, to form a plurality of wire end pairs, such as the wire end pairs 32, 42 shown in FIGS. 2 and 3.

As will be described further in detail, adjacent paired wire ends 28 are joined to form an electrical connection by soldering one wire end to its paired wire end to form a soldered joint, where each pair of wires is individually soldered by immersion of the wire end portion 14 of the stator 10 in a molten solder bath, to form a plurality of electrical connections. The resultant weave pattern and plurality of soldered joints determines the path of the current flow through the winding 12.

FIG. 2 shows, by way of non-limiting example, a representative perspective sectional view of the weave pattern, also referred to as the winding pattern, of the wire end portion 14 of stator 10 in additional detail. The collective wire ends 28 of bar pins 24 have been arranged in four layers in the slots 18 of the lamination stack 16, where the outermost layer includes a plurality of wire ends in the plurality of slots 18 closest to the outer diameter of the lamination pack 16, and the innermost layer includes a plurality of wire ends in the plurality of slots 18 closest to the inner diameter of the lamination stack 16. As shown in FIGS. 2 and 3A-3B, the plurality of wire ends forming the outermost or first layer of the winding 12 are identified in FIGS. 2-6B as wire ends 34. The second layer of the winding 12, which is proximate to the first layer, is formed of a plurality of wire ends identified as wire ends 36. The third layer of the winding 12, which is proximate to a fourth or innermost layer, is formed of a plurality of wire ends identified as wire ends 44. The innermost or fourth layer is formed of a plurality of wire ends identified as wire ends 46.

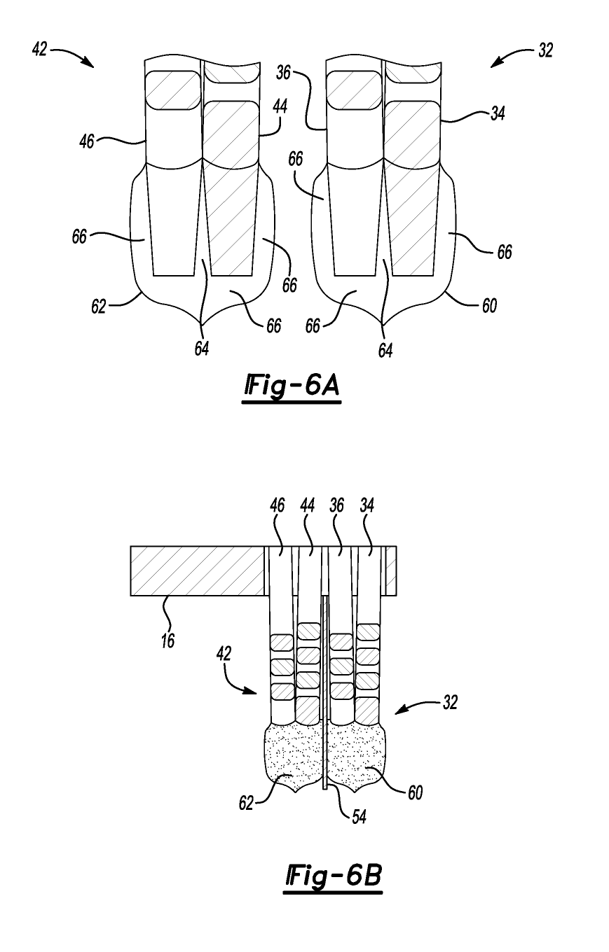

FIGS. 2, 3A and 3B show each of the wire ends 34 in the first layer is bent such that it is proximate to and paired with a wire end 36 in the second layer, to form a wire end pair 32. The wire end 34 is joined by soldering to its paired wire end 36 such that the solder forms a solder joint 60 (see FIGS. 5-6B) providing an electrical connection between the wire end 34 and the wire end 36 in the wire end pair 32. The plurality of soldered wire end pairs 32 may be configured to comprise a first winding set, as described herein.

Similarly, each of the wire ends 44 in the third layer is bent such that it is proximate to and paired with a wire end 46 in the fourth layer, to form a wire end pair 42. The wire end 44 is joined by soldering to its paired wire end 46 such that the solder forms a solder joint 62 (see FIGS. 6A-6B) providing an electrical connection between the wire end 44 and the wire end 46 in the wire end pair 42. The plurality of soldered wire end pairs 42 may be configured to comprise a second winding set, as described herein. The wire ends 34, 36, 44, 46 may be collectively referred to as the wire ends 28 (see FIG. 1), when discussing the plurality of wire ends comprising the wire end portion 14.

The winding 12 may be configured to include a first winding set and a second winding set. The first winding set may be comprised of the plurality of bar pins 24 forming the first layer of wire ends 34 and the second layer of wire ends 36, e.g., the first winding set may be comprised of the plurality of wire pairs 32. The second winding set may be comprised of the plurality of bar pins 24 forming the third layer of wire ends 44 and the fourth layer of wire ends 46, e.g., the second winding set may be comprised of the plurality of wire pairs 42.

As described previously, electrical current is conducted through the winding 12 via a weave pattern established by the bar pins 24 and the plurality of solder joints 60, 62 connecting each of the wire end pairs 32, 42. The wire end pairs are configured and bent such that each wire end pair 32, 42 is separated from each other wire end pair 32, 42 to minimize the potential for forming an electrical connection between any two wire end pairs. For example, and referring to FIGS. 1 and 2, each wire end pair 32 is arranged in the first winding set such that it is separated from an adjacent wire end pair 32 by a space or interval 38, and each wire end pair 42 is arranged in the second winding set such that it is separated from an adjacent wire end pair 42 by a space or interval 38. Referring now to FIGS. 3A and 3B, it is shown that each wire end pair 32 is separated from an adjacent wire end pair 42 by a space or interval 48, wherein the space or interval 48 is established by the spacing of the second layer of wire ends 36 from the third layer of wire ends 44.

The wire ends are configured and bent such that the wire ends in each wire end pair are positioned proximate to each other to facilitate formation of the solder joint between and surrounding each of the two wire ends in the wire end pair. For example, and as shown in FIG. 3B, the wire ends 34, 36 are positioned proximate to each other to facilitate formation of the solder joint 60 on the wire end pair 32 formed by wire ends 34 and 36, as shown in FIG. 6A. As shown in FIG. 3B, the wire end 34 is defined by a surface 28B which is proximate to a surface 28B defined by the wire end 36, such that surfaces 28B can be referred to as proximate surfaces. Similarly, the wire end 44 is defined by a surface 28D which is proximate to a surface 28D defined by the wire end 46, such that surfaces 28D can be referred to as proximate surfaces.

As shown in FIG. 3B, each wire end pair defines a perimeter surface comprised of the exterior and non-proximate surfaces of the wire ends comprising the wire end pair. For example, the perimeter surface 28A of wire end pair 32 is comprised of the perimeter surfaces 28A on wire end 34 and the perimeter surfaces 28A on wire end 36. The perimeter surface 28C of wire end pair 42 is comprised of the perimeter surfaces 28C on wire end 44 and the perimeter surfaces 28C on wire end 46.

FIG. 6A shows the solder joints 60, 62 formed on the respective wire end pairs 32, 42 are shown. The solder joint 60, as shown in FIG. 6A and referring to FIG. 3B, may be defined by a portion of solder 64 between the proximate surfaces 28B of the wire ends 34, 36 of the wire end pair 32, and may be further defined by a coating of solder 66 in contact with the perimeter surfaces 28A of the wire end pair 32, wherein the portion of solder 64 and the coating of solder 66 provides an electrical connection between the wire ends 34, 36 of the wire end pair 32. The solder joint 60, configured as shown in FIG. 6A and including the portion of solder 64 between the wire end pair 34, 36 and the coating of solder 66 provides an increased surface area and cross-sectional area to carry electrical current as compared with an arc welded joint.

Similarly, the solder joint 62, as shown in FIG. 6A and referring to FIG. 3B, may be defined by a portion of solder 64 between the proximate surfaces 28D of the wire ends 44, 46 of the wire end pair 42, and may be further defined by a coating of solder 66 in contact with the perimeter surfaces 28C of the wire end pair 42, wherein the portion of solder 64 and the coating of solder 66 provides an electrical connection between the wire ends 44, 46 of the wire end pair 42. The solder joint 62, configured as shown in FIG. 6A and including the portion of solder 64 between the wire end pair 44, 46 and the coating of solder 66 provides an increased surface area and cross-sectional area to carry electrical current as compared with an arc welded joint.

By comparison, the electrical current in a welded joint (not shown) is passed only through the fused area forming the weld comprised of parent metal from the wire ends, which can be of variable size and susceptible to welding defects including porosity, microcracks, and contamination, or of variable cross-section due to poor fit between or variability in the proximity of the wire ends in each wire end pair to each other during welding, which may reduce the current carrying capacity of the weld. A smaller sized weld may be susceptible to overloading during current loading, causing weld failure and shorting the electrical circuit within the winding. Accordingly, a soldered joint, such as joint 60 in a non-limiting example, provides a greater current carrying area through a first current path defined by the filler solder 64 between the proximate surfaces 28B of the respective wire ends 34, 36, and through a secondary current path provided by the coating portion 66, thereby providing improved electrical performance, enhanced current carrying capacity and decreased susceptibility of the rotor to overloading and electrical shorts.

Using a solder joint, such as joint 60, to provide the electrical connection between the wire ends 34, 36 is further advantaged by a decreased sensitivity to the configuration of the wire end pair 32, and specifically, to the spacing between the proximate surfaces 28A. Whereas the ability to form a weld between the wire ends deteriorates as the spacing between the proximate surfaces 28A of the wire ends 34, 36 increases, the flow of solder between the proximate surfaces 28A during immersion in a molten solder bath, as will be discussed in additional detail, provides a portion of solder 64 filling the space between the proximate surfaces 28A, wherein the solidified filler solder 64 is electrically conductive. It would be understood that solder joint 62 would be similarly advantaged, being the same or similarly configured as joint 60.

FIG. 4 shows a molten solder bath 50, also referred to as a solder bath, which contains a quantity of molten solder 52. The solder 52 may be of any solder material, such as a tin-based solder, suitable for soldering of copper wire or other wire used to form the bar pins 24. For simplicity and clarity of illustration, FIG. 4 shows only the first winding set of stator 10, consisting of wire ends 34 and 36 forming wire end pairs 32. Not shown, but understood, the entire wire end portion 14 consisting of wire end pairs 32 and 42 would be immersed into the molten solder bath, which provides the advantage of reduced processing time to join the wire end pairs of stator 10 as compared with, for example, individually welding each of the wire end pairs 32 and 42, or welding the first winding set then welding the second winding set in subsequent operations. As shown in FIG. 4, the wire end pairs 32, 42 (see FIGS. 6A-6B) are soldered by immersing the wire end portion 14 of the stator 10 in the molten solder bath 52, to form a solder joint 60, 62 (see FIGS. 6A-6B) on each respective wire end pair 32, 42.

The molten solder 52 may be ultrasonically activated or excited, whereby the ultrasonic energy introduced into the molten solder 52 may eliminate the need for flux and facilitate wetting of each of the plurality of wire ends 34, 36, 44, 46 (collectively, wire ends 28, see FIG. 1) by the molten solder 52. The molten solder 52 may be ultrasonically activated to cause cavitation of the molten solder, which may have a scrubbing effect on the collective wire ends 28 to mechanically remove oxides from the surfaces of wire ends 28 to clean the wire ends 28 and thereby facilitate wetting of the molten solder 52 to the metal of the wire ends 28.

The process of immersing the wire end portion 14 into the molten solder 52 to form the solder joints 60, 62 may be controlled by controlling one or more factors, which may be controlled separately or in combination and in relation to each other. For example, the duration of immersion of the wire end portion 14 in the molten solder 52 may be controlled to a predetermined time, to ensure adequate wetting of the perimeter surfaces 28A, 28C of the wire end pairs with molten solder 52, and wicking of molten solder 52 into the space between the proximate surfaces 28B, 28D of the wire end pairs to form each of the solder joints 60, 62. The duration of immersion may be controlled, by way of non-limiting example, by lowering the wire end portion 14 of the stator 10 into the molten solder 52 in a continuous flow configuration using a conveyor, which may be an overhead conveyor, where the conveyor speed is adjustable to control the duration of immersion.

As another example, the depth of immersion of the wire end portion 14 in the molten solder 52 may be controlled such that the wire end portion 14 is immersed to a depth d, as shown in FIG. 4. The depth d may be determined based on the configuration of the exposed surface of wire end 28, e.g., the surface area from which the insulation 26 has been stripped or otherwise removed. The depth d may be determined based on other factors, such as the optimized depth to ensure wicking and wetting of molten solder 52 on the surfaces 28A-28D of the wire ends 28 in the appropriate pattern to form the solder joints 60, 62, and/or to prevent application of molten solder 52 to other areas or surfaces of the stator 10, such as the insulated portion of the bar pins 24 or the lamination stack 16. In one non-limiting example, the depth d is established such that the depth d>2w+x, where w is the width of each wire end 28, and x is the width of the space defined by the proximate surfaces 28B for wire end pair 32 and proximate surfaces 28D for wire end pair 42, respectively; and such that the depth d<h, where h is the height, e.g., the length, of the stripped portion of the wire end 28. Additionally, the width of the space x may be controlled to ensure the portion of molten solder 64 is held by capillary action in the space between the proximate surfaces 28B, 28D of the respective wire end pair 32, 42, after removal of the wire end portion 14 from the solder bath 52.

By way of non-limiting example, the stator 10 may be moved by robot to immerse the wire end portion 14 into and out of the molten solder 52 at a predetermined cycle or interval, where the depth of immersion of the wire end portion 14 in the molten solder 52 may be controlled, for example, by controlling the height of the conveyor or movement of the robot using the non-limiting examples previously discussed, such that the wire end portion 14 is immersed to the depth d.

Other factors, such as the temperature and viscosity of the molten solder 52 may be controlled to predetermined values, to ensure that each of the plurality of wire ends 28 is wetted by molten solder sufficiently to form a solder joint 60, 62 with the wire ends of each respective pair of wire ends (34, 36 forming wire end pair 32; 44, 46 forming wire end pair 42), the solder joint 60, 62 having structural integrity and configured to provide an electrical connection between the wire ends in the respective wire end pair.

The method and system may further include immersing the wire end portion 14 in a preconditioning bath (not shown) or applying a flux to the wire ends (not shown) prior to immersing the wire end portion 14 in the molten solder bath 50, to prepare the wire ends 28 for soldering by cleaning and/or removing oxidation from the wire ends 28 to facilitate wetting of the collective wire ends 28 by the molten solder 52.

The method and system may further include pre-applying a solder coating (not shown) to the wire ends 28 to facilitate wetting of the wire ends 28 during immersion into the solder bath 52. The solder may be pre-applied to the wire ends 28, by way of a non-limiting example, after the insulation 26 is stripped from the wire ends 28 and prior to bending the wire to form the bar pin 24. Pre-application of solder to the stripped wire ends 28 may eliminate the need for fluxing or other preconditioning of the wire ends 28 prior to immersion in the molten solder 50, and/or may eliminate the need for ultrasonic excitation of the solder bath 52.

FIG. 5 shows the wire end portion 14 of stator 10 after removal from the solder bath 50. A solder joint 60 has been formed on each wire end pair 32 consisting of a wire end 34 and a wire end 36, by solidifying the molten solder 52 which was wetted to or wicked between the surfaces 28A and 28B of wire ends 34, 36 during immersion of the wire end portion 14 in the solder bath 50. For simplicity and clarity of illustration, FIG. 5 shows only the first winding set of stator 10, consisting of paired wire ends 34 and 36 joined by a solder joint 60. Not shown, but understood, each wire end pair 42 consisting of wire ends 44, 46 of the second winding set of stator 10 are joined by soldering to form a solder joint 62 on each respective wire end pair 42 (see FIGS. 6A and 6B).

FIG. 6A is a cross-sectional illustration of the wire end portion 14 after forming the solder joints 60, 62 by immersing the wire end portion 14 in the solder bath 52. As described previously, each of the plurality of wire end pairs 32 are separated from an adjacent one of the plurality of wire end pairs 42 by a space 48 (see FIGS. 3A and 3B) between the adjacent wire end pairs 32, 42. The wire end pairs 32, 42 and space 48 are configured such that each wire end pair 32, 42 is separated from an adjacent wire end pair 42, 32, to prevent wicking of the molten solder 52 therebetween during immersion of the wire end portion 14 in the molten solder bath 52, and to facilitate formation of the separate and respective solder joints 60, 62 on their respective wire end pair 32, 42. The wire end pairs 32, 42 may be separated during the bending process used to form the weave pattern of the wire end portion 14, thereby forming the space 48.

The wire end pairs 32, 42 may be separated, in a non-limiting example, using a separator 54, as shown in FIG. 6B, during immersion of the wire end portion 14 in the molten solder 52, to prevent formation of a soldered connection between the first and second winding sets and/or between adjacent pairs of wire ends 32, 42. The separator 54 may be configured as an insert, which may be a reusable or disposable insert, made of a material which is resistant to wetting by molten solder, such as an epoxy or phenolic resin, fiberglass, or other polymer, or other suitable material including a paper based product. The separator 54 may be configured, in a non-limiting example, in a generally cylindrical or annular shape, and inserted between the first and second winding set, e.g., between the second layer of wire ends 36 and the third layer of wire ends 44, prior to immersing the wire end portion 14 in the molten solder bath 50, and subsequently removed after forming the solder joints 60, 62. Other shapes and materials may be used to provide a separator 54 configured to separate the adjacent wire end pairs 32, 42.

Referring to FIG. 6A, shown are the solder joints 60, 62 formed on the respective wire end pairs 32, 42. Referring now to solder joint 60, the solder joint 60 includes a portion of solder 64 which has been wicked into the space between proximate surfaces 28B (see FIG. 3B) of the wire ends 34, 36 of the wire end pair 32, during immersion of the wire ends 34, 36 in the molten solder 52. The wicked solder 64, which may also be referred to as the filler solder, is solidified to substantially fill the space between the proximate surfaces 28B of the wire end pair 32 to provide an electrical connection between the wire ends 34, 36. Variation in the weave pattern or fit between the wire ends 34, 36 is thereby compensated for by filling the space between the proximate surfaces 28B with wicked solder.

The solder joint 60 includes a coating of solder 66 in contact with the perimeter surfaces 28A (see FIG. 3B) of the wire end pair 32, which is formed by metallurgically wetting the copper of the wire ends 34, 36 with the molten solder 52 during immersion of the wire ends 34, 36 in the molten solder bath 50. The wetted molten solder 52 solidifies to form the coating of solder 66 in contact with the perimeter surfaces 28A to provide an electrical connection between the wire ends 34, 36 of the wire end pair 32. The coating of solder 66 surrounds the perimeter surfaces 28A to surround the wire end pair 32. Accordingly, the solder joint 60, configured as shown in FIG. 6A includes the filler solder 64 and the solder coating 66 each providing a conductive path between the wire ends 34, 36, and collectively providing an increased surface area and cross-sectional area to carry electrical current as compared with an arc welded joint, therefore decreasing susceptibility to electrical overload of the winding 12.

Similarly, the solder joint 62 includes a portion of solder 64 which has been wicked into the space between proximate surfaces 28D (see FIG. 3B) of the wire ends 44, 46 of the wire end pair 42, during immersion of the wire ends 44, 46 in the molten solder 52. The wicked or filler solder 64 substantially fills the space between the proximate surfaces 28D of the wire end pair 42 to provide an electrical connection between the wire ends 44, 46, as described for the solder joint 60. The solder joint 62 further includes forming a coating of solder 66 in contact with the perimeter surfaces 28C (see FIG. 3B) of the wire end pair 42, using the method as described for the solder joint 60, where the coating portion 66 of solder joint 62 is in contact with the perimeter surfaces 28C to provide an electrical connection between the wire ends 44, 46 of the wire end pair 42. The coating of solder 66 surrounds the perimeter surfaces 28C to surround the wire end pair 42. Accordingly, the solder joint 62, configured as shown in FIG. 6A includes the filler solder 64 and the solder coating 66 each providing a conductive path between the wire ends 44, 46, and collectively providing an increased surface area and cross-sectional area to carry electrical current as compared with an arc welded joint, therefore decreasing susceptibility to electrical overload of the winding 12.

While the best modes for carrying out the invention have been described in detail, those familiar with the art to which this invention relates will recognize various alternative designs and embodiments for practicing the invention within the scope of the appended claims.

1. A method of joining the wire ends of a stator assembly, the method comprising:
immersing a wire end portion of a stator assembly in a molten solder bath, wherein the wire end portion includes a plurality of wire ends configured as a plurality of wire end pairs, and such that each of the plurality of wire ends is wetted by molten solder; and
solidifying the molten solder to form a plurality of solder joints, wherein each respective one of the plurality of solder joints joins the respective wire ends of each respective one of the plurality of wire end pairs to provide an electrical connection between the respective wire ends of the respective one of the plurality of wire end pairs.

2. The method of claim 1, wherein the stator assembly is configured as a bar pin stator including a plurality of bar pins, each bar pin including one or more wire ends.

3. The method of claim 1, further comprising:
wetting the proximate surfaces of the wire ends of each of the plurality of wire end pairs with a portion of molten solder; and
wetting the perimeter surfaces of each of the plurality of wire end pairs with a coating of molten solder;
wherein the solder joint includes the portion of solder and the coating of solder.

4. The method of claim 1, further comprising:
ultrasonically activating the solder bath such that each of the plurality of wire ends is wetted by the molten solder.

5. The method of claim 1, further comprising at least one of:
controlling the duration of immersion of the wire end portion in the molten solder bath to a predetermined time;
controlling the temperature of the molten solder bath to a predetermined temperature;
controlling the viscosity of the molten solder bath to a predetermined viscosity; and
controlling the depth of immersion of the wire end portion in the molten solder bath,
such that each of the plurality of wire ends is wetted by molten solder.

6. The method of claim 1, further comprising at least one of:
immersing the wire end portion in a preconditioning bath prior to immersing the wire end portion in the molten solder bath; and
applying a flux to the plurality of wire ends prior to immersing the wire end portion in the molten solder bath.

7. The method of claim 1, further comprising:
applying solder to the plurality of wire ends prior to immersing the wire end portion of the stator assembly in the molten solder bath.

8. The method of claim 1, further comprising:
configuring the plurality of wire end pairs to separate each one of the plurality of wire end pairs and an adjacent one of the plurality of wire end pairs, to prevent wicking of the molten solder therebetween.

9. The method of claim 1, wherein the plurality of wire end pairs are configured in a first winding set and a second winding set, further comprising:
separating the plurality of wire end pairs of the first winding set from the plurality of wire end pairs of the second winding set during immersion of the wire portion end to prevent formation of an electrical connection between the first winding set and the second winding set.

10. The method of claim 1, further comprising:
presenting the stator assembly for immersion in the molten solder bath using one of a conveyor and a robot.

11. A system of joining the wire ends of a stator assembly, the system comprising:
a molten solder bath configured such that a wire end portion of a stator assembly is immersible in the molten solder bath to form a solder joint in each of a plurality of wire end pairs of the stator assembly.

12. The system of claim 11,
wherein the stator assembly includes a plurality of bar pins; and
wherein each of the plurality of bar pins includes one or more wire ends.

13. The system of claim 12, wherein solder has been applied to the wire ends of the bar pins.

14. The system of claim 11, wherein the molten solder bath is configured to control at least one of:
the depth of immersion of the wire end portion in the molten solder,
the viscosity of the molten solder bath;
the temperature of the molten solder, and
the duration of time the wire end portion of the stator is immersed in the molten solder bath,
to form the solder joint in each of a plurality of wire end pairs of the stator.

15. The system of claim 11, further comprising at least one of:
a preconditioning bath configured such that the wire end portion of the stator assembly is immersible in the preconditioning bath prior to being immersed in the molten solder bath; and
a flux applicable to the plurality of wire ends.

16. The system of claim 11, further comprising:
a device to present the stator assembly for immersion in the molten solder bath, wherein the device is one of a conveyor and a robot.

17. The system of claim 11, wherein the plurality of wire end pairs of the stator assembly are configured in a first winding set and a second winding set, further comprising:
a separator configured to separate the plurality of wire end pairs of the first winding set from the plurality of wire end pairs of the second winding set during immersion of the wire portion end to prevent formation of an electrical connection between the first winding set and the second winding set.

18. A stator assembly comprising:
a plurality of bar pins configured to define a wire end portion including a plurality of wire ends;
wherein the plurality of wire ends are configured in a weave pattern defining a plurality of wire end pairs;
wherein each of the plurality of wire end pairs includes a solder joint formed by immersing the wire end portion into a molten solder bath; and
wherein the solder joint of each of the wire end pairs forms an electrical connection such that an electrical current is conductible through the weave pattern.

19. The stator assembly of claim 18, wherein the solder joint of each of the plurality of wire end pairs is defined by a portion of solder between the proximate surfaces of the respective wire ends of each respective wire end pair, wherein the portion of solder provides an electrical connection between the respective wire ends.

20. The stator assembly of claim 18, wherein the solder joint of each of the plurality of wire end pairs is defined by a coating of solder in contact with a perimeter surface of each respective wire end pair, wherein the coating of solder provides an electrical connection between the respective wire ends.
